(19) United States
(12) Patent Application Publication
(10) Pub. No.: US 2019/0183289 A1
(43) Pub. Date: Jun. 20, 2019

(54) FOOD PROCESSING APPARATUS

(71) Applicant: ITSY PRODUCTS LIMITED, Worsley, Manchester (GB)

(72) Inventor: Christopher David GRUNWELL, Worsley, Manchester (GB)

(73) Assignee: ITSY PRODUCTS LIMITED, Worsley, Manchester (GB)

(21) Appl. No.: 16/311,375

(22) PCT Filed: Jun. 1, 2017
(86) PCT No.: PCT/GB2017/051580

§ 371 Date: Dec. 19, 2018

(30) Foreign Application Priority Data
Jun. 21, 2016 (GB) 1610770.8
Mar. 3, 2017 (GB) 1703445.5

(51) Int. Cl. A47J 43/046; B01F 13/10; B01F 15/00

(52) U.S. Cl. CPC A47J 43/046; B01F 13/1041; B01F 15/00519; B01F 2215/0026; B01F 2013/1077; B01F 2015/00597; B01F 15/00538

(57) ABSTRACT

A food processing apparatus includes a blending module having a motor releasably connectable to a blending rotor which is rotatable within a liquid-tight container thereby to morcelate food, wherein the motor is connected to a battery contained within blending module, the blending module being releasably engagable with a charging module connectable to a mains electrical power supply, the blending and charging modules being electrically connectable to each other thereby to supply recharging power to the blending module to recharge the battery.

The present invention relates to a food processing apparatus, such as a blender, for example.

Food blenders are known. A popular current design is shown in US design patent 487,668 for example. GB2506926 discloses a portable blender for use in creating baby food. The present invention provides a further alternative having advantages over the foregoing designs.

Embodiments of the invention will now be described, by way of example, and with reference to the accompanying drawings in which:

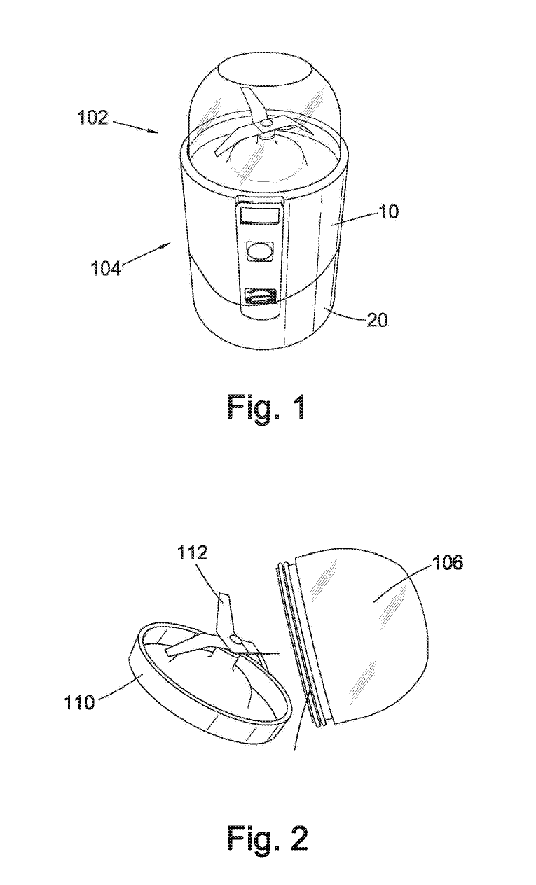

FIG. 1 is a perspective view of a food processing apparatus according to a first embodiment of the present invention;

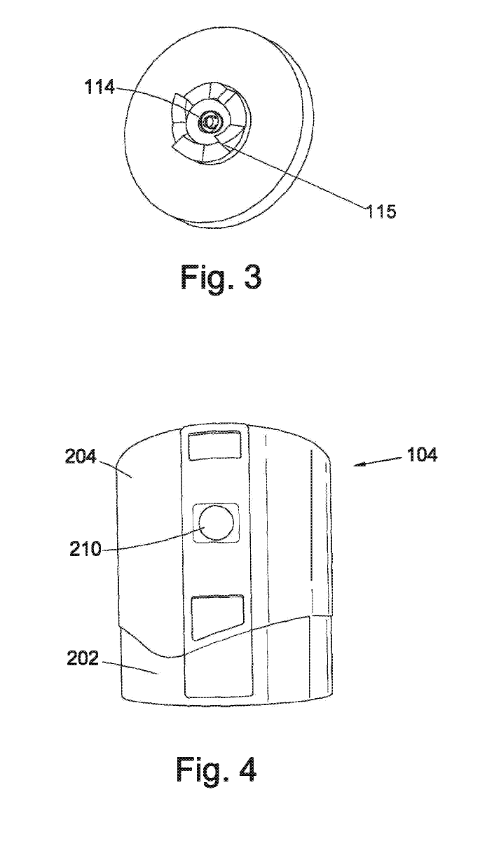

FIGS. 2 and 3 are perspective views of parts of a blending module of the food processing apparatus;

FIG. 4 is an elevation of the lower part of the blending module;

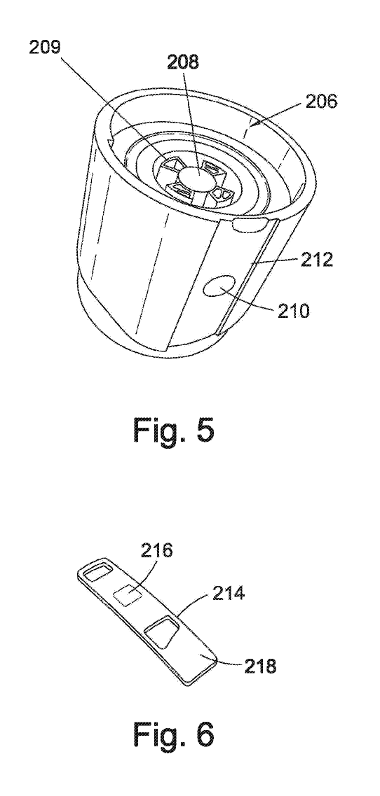

FIG. 5 is a perspective view of a detail of the lower part of FIG. 4;

FIG. 6 is a perspective view of a cover used in the module of FIG. 4;

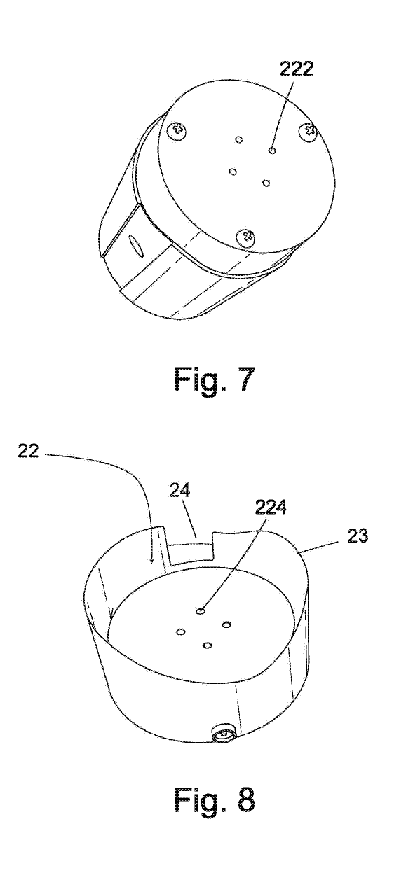

FIG. 7 a perspective view of a further detail of the module part of FIG. 4;

FIG. 8 is a perspective view of a pedestal shown in FIG. 1;

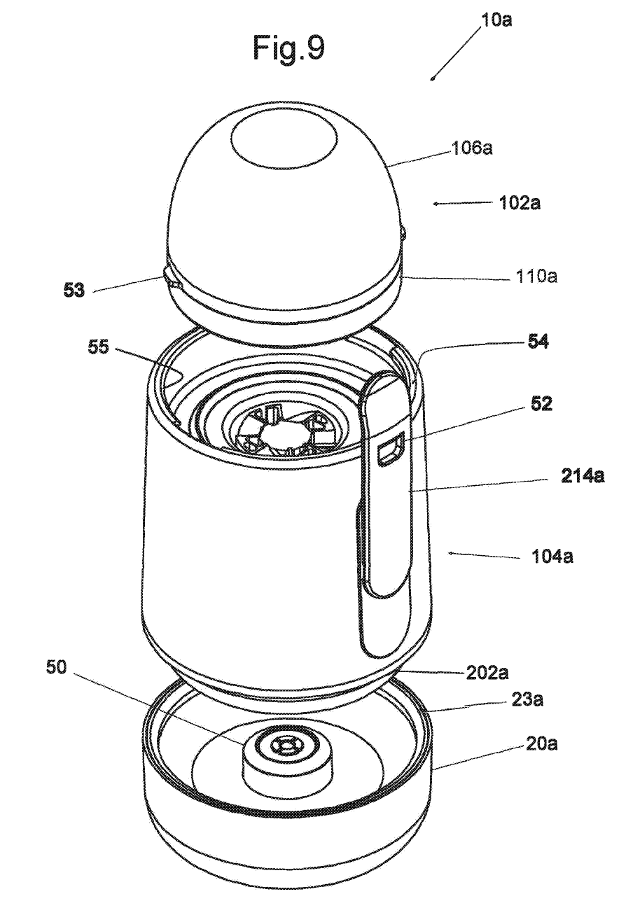

FIG. 9 is a perspective view of a food processing apparatus according to a second embodiment of the present invention;

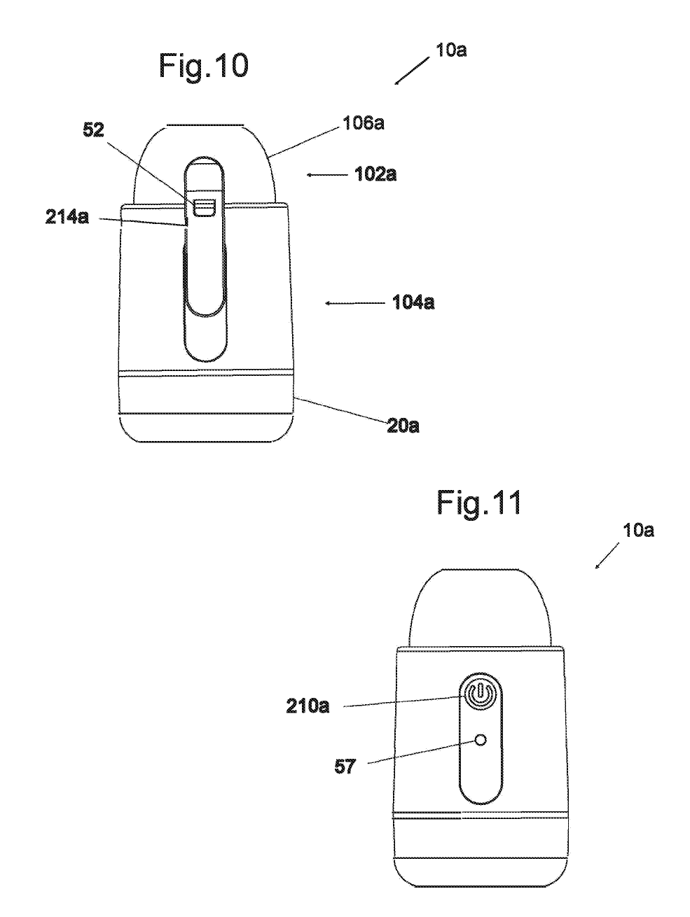

FIG. 10 is a side view of the apparatus of FIG. 9, showing a cover part; and

FIG. 11 corresponds to FIG. 10 but omits the cover part.

Referring now to FIG. 1, a food processing apparatus, in the present embodiment a food blender, comprises a battery-powered blending module 10, which is releasably locatable upon a charging module which, in the illustrated embodiment has the form of a pedestal 20. The pedestal 20 is connectable to a mains electricity supply and acts as a power supply for recharging the blender module 10. The blending module 10 comprises upper and lower parts 102, 104. The upper part 102 is illustrated in detail in FIGS. 2 & 3 and comprises a domed cover 106 which may be fastened by a screw thread 108 to a mounting plate 110 to form a liquid tight seal. A blending rotor 112 is mounted via a bearing for rotation relative to the mounting plate 110. The rotor 112 is connected to a driven rotary coupling part 114 which is mounted on the underside of the plate 110. When the domed cover 106 is fixed by means of the screw thread to the plate 110, a liquid tight container is formed within which food, upon rotation of the blending rotor 112, will be morcelated and, thereby liquidised. Once the food has been liquidised the upper part 102 is removed and inverted and the domed cover 106 can then be removed from its screw-threaded engagement with the plate so that it may typically be used as a serving receptacle from which to serve the liquidised food or drink. In the present example the size and configuration of the cover is such as to provide a dish for baby food. It may, alternatively, however have a size and shape that facilitates the provision of other functions, such as a drinks receptacle for smoothies or shakes, for example.

Referring additionally to FIG. 4, the lower part 104 of the blending module 10 comprises a lower portion 202 which, when the blending module 10 is engaged with the pedestal 20, sits within a bowl 22 formed in the pedestal by an upstanding peripheral wall 23 (see FIG. 8) to assist stable location of the blending module 10 therein. The lower portion 202 is connected to a cover 204. The upper surface of the cover forms a dish 206 (see FIG. 5) within which is concentrically housed a driving rotary coupling part 208. The driven rotary coupling part 114 is seen in FIG. 3 to have drive dogs 115. The driving rotary coupling part 208 has complementary recesses 209 to receive the drive dogs 115. Seating the upper part 102 upon the lower part 104 brings these parts into engagement, forming an operative coupling between the blending rotor 112 and the driving rotary coupling part 208, which is itself drivable by an electric motor (not shown) housed in the lower part 104. A button 210 on the side of the cover 204 switches on the power supply within the lower part 104 of the blending module to make electrical power from the battery available to the motor (not shown). The motor is switched on in a manner known per se (see for example actuation of the Nutribullet® food blender) by depression and rotation of the upper part 102 within the dish. That depression and rotation action causes electrical actuation of the motor thereby causing the driving rotary coupling part 208 and hence the blending rotor 112 to rotate.

A feature of the present embodiment of the invention is that, being battery operated, the blending module 10 is portable. This enables the blending module 10 to be used at remote locations where no mains electrical power is available, such as in the countryside. To preserve battery life, the battery power to the motor will preferably be switched off using the button 210 when the blender module 10 is not in use. The design requirements for portability, however, mean that the button is readily accessible and is therefore susceptible to accidental depression, potentially leading to the blender being ‘live’ for long periods when not in use, which will needlessly dissipate the charge in the battery. To obviate such a risk, the lower part 104 of the blender module comprises a vertically-extending channel 212 into which a releasable cover 214 may be inserted and retained. The cover is illustrated in more detail in FIG. 6. When being transported, the cover 214 slots into the channel 212 and prevents any accidental force on the upper part 104 which may be applied during transportation from depressing the button 210 and accidentally switching the power on. Optionally, the cover 214 additionally comprises a recess 216 which accommodates the button 210. In a modification, a recess may be formed on the outer side at the same location to provide a space for branding or other marking. At one end the cover additionally includes a slightly dished tab 218. The tab 218 enables the cover 214 to serve as a spoon with which the blended food from the dish formed by the domed cover 106 may be eaten (or, more usually where the blender is used to make purée for consumption by babies or the elderly, to serve it). Referring additionally to FIG. 8, the pedestal 20 comprises a recess 24 in the lip of the bowl 22 which accommodates the tab (having regard to its titled angle) while the blender module 10 is located on the pedestal 20 for recharging.

Referring to FIGS. 7 and 8, the lower portion 202 has four electrical contact pins 222. These connect with four correspondingly located contact pins 224 in the pedestal 20. The cover of the lower part of the blending module and the bowl of the pedestal have an alignment structure which ensures that the blender module can only be located in the bowl 22 in an orientation which ensures that the correct polarity of the contact pins 222 and 224 is achieved. In the present embodiment that alignment structure is provided by the contoured shape of the lip of the bowl 22 in the pedestal and the contour of the lower edge of the cover 204 which are configured only to engage in predetermined orientations of the two modules.

A further embodiment of the present invention is depicted in FIGS. 9 to 11 and has much in common with the first embodiment, once more comprising a blending module 10a comprising an upper part 102a and a lower part 104a, the blending module being locatable upon a charging module 20a. The upper part 102a once more comprises a domed cover 106a attachable by means of a screw thread (not seen in these drawings) to a mounting plate 110a. The interior of the upper part 102a is not seen in these drawings but it contains a blending rotor journaled upon the mounting plate 110a as before.

The second embodiment differs from the first in that the blending module 10a is able to seat upon the charging module 20a, making electrical contact for charging of the battery, in any rotational position. Peripheral wall 23a of the charging module 20a has in this embodiment an annular form. Within it is a concentrically arranged and circular electrical connector 50 which in this embodiment has a male formation receivable in a complementary female connector (not shown) formed in and concentric with the circular underside of the lower portion 202a of the lower part 104a. It is consequently not necessary for the user to rotationally align the blending module 10a with respect to the charging module 20a in order to seat one upon the other. In this embodiment only two electrical connections are made through the connector 50, for supply of electrical power. Battery management and charging circuitry are carried in the blending module's lower part 104a.

Looking at FIG. 11, the lower part 104a of the blending module 10a has a radially facing user operable button 210a controlling a user operable switch, not shown. Application of pressure to the button 210 changes the switch state. It may be a soft touch button. In the present embodiment the switch itself is actuable through a skin of flexible material, specifically silicone. Other types of switch could be substituted.

This embodiment also differs from the first in that the motor is switched on and off simply by depressing/releasing the button 210a, and not by movement of the top part 102a, although there is a safety switch (not shown) carried by the lower part 104a and arranged such that its state is changed when the cover 106a is properly engaged, through the mounting plate 110a, with the lower part 104a. The safety switch must be actuated in this manner to enable supply of electrical power to the motor. This ensures that the motor cannot be run unless the cover 106a is in place, covering the blending rotor 112. If the device were operable without the cover 106a in place then the exposed and spinning blending rotor 112 could present an injury risk. The safety switch may simply be connected in series with the motor.

The lower part 104a also carries an indicator device 57 for providing information about the status of the blending module 10. In the present embodiment this takes the form of an LED light which is able to adopt the following states:
constant green light—power on
constant red light—low battery
flashing red light—over-current warning, e.g. due to stalling of motor
flashing green light—charging
solid green light whilst on charge—fully charged.

The upper part 102a is releasably securable to the lower part 104a through a part turn lock comprising (a) radially outwardly projecting lugs 53 formed on the cover 106a which engage (b) radially inwardly projecting tongues 55 which extend around part of the circumference of the dish formation 206a of the upper part. Once the upper part 102a is seated upon the lower part 104a, turning it through a part turn engages the lugs 53 beneath respective tongues 55 to keep the two parts together. Reversing this rotation allows the parts to be separated.

Similarly to the first embodiment, the blending module 10a is provided with a removable cover 214a which serves two purposes: (a) it is shaped to be usable as a spoon for use with the liquidized food and (b) it is attachable to the blending module 10 over the user operable button 210a to prevent its accidental actuation. In the present embodiment the cover 214a has a clip feature 52 configured to clip over an upper lip 54 of the lower part 104a. A secondary means of attachment, separated from the clip feature 52 along the length of the cover 214a, is also provided. This is not seen in the drawings but comprises a pip on the cover 214a receivable as a press or clip fit in a complementary recess in the exterior of the lower part 104a. In other embodiments the cover 214a could have some suitable female formation for receipt of a complementary male feature part carried by the lower part 104a.

However the releasable attachment is achieved, the cover part 214a covers the user operable switch, so that the switch cannot be actuated without first removing the cover part 214a.

In the present embodiment, the cover 214a is transparent, so that the switch 210a is visible beneath it. One advantage for first time or infrequent users is that one does not waste time in use looking for a concealed switch. Also the indicator device 57 is visible through the cover 214a.

Numerous modifications and developments are possible within the scope of the invention as set out in the appended claims. For example in one such alternative embodiment of the invention inductive electrical charging is used to recharge the battery in the blender module (such as is nowadays frequently used in wet environments for such things as electric toothbrushes).

1. A food processing apparatus comprising: a blending module having a motor releasably connectable to a blending rotor which is rotatable within a liquid-tight container thereby to morcelate food wherein; the motor is connected to a battery contained within the blending module; the blending module being releasably engagable with a charging module connectable to a mains electrical power supply; and the blending and charging modules being electrically connectable to each other thereby to supply recharging power to the blending module to recharge the battery.

2. The food processing apparatus according to claim 1, wherein the blending module comprises a user operable switch controlling supply of electrical power to the motor, and a cover releasably attachable to the blending module to cover the switch and so prevent its inadvertent actuation.

3. The food processing apparatus according to claim 2, wherein the switch comprises a button located on an external surface of the blending module and depressable to switch on electrical power.

4. The food processing apparatus according to claim 2, wherein the cover is configured to clip to the blending module.

5. The food processing apparatus according to claim 4, wherein the cover has a clip portion for engaging a lip formed on the blending module, and a secondary attachment separated from the clip portion.

6. The food processing apparatus according to claim 3, wherein the button is located in a channel on the external surface of the blending module and the cover is releasably retainable within the channel over the button.

7. The food processing apparatus according to claim 2, wherein the cover is configured to be used as a spoon.

8. The food processing apparatus according to claim 2, wherein the cover comprises a tab at one end which serves as a spoon when the cover is detached.

9. The food processing apparatus according to claim 1, wherein the blending and charging modules each comprise electrical contact pins which are mutually engagable and the blending and charging modules further comprise an alignment structure to ensure that the blending and charging modules can only mutually engage in an orientation which ensures correct polarity of the contact pins.

10. The food processing apparatus according to claim 9, wherein the alignment structure is provided by a contoured shape of at least a part of the charging module and a reciprocally contoured shape on the blending module.

11. The food processing apparatus according to claim 1, wherein the blending module comprises an upper part comprising the blending rotor mounted on a plate and a detachable cover engagable with the plate to create a liquid-tight enclosure in which the rotor rotates, wherein the rotor is connected to a first rotary coupling part mounted on an external surface of the plate; and a lower part comprising a second rotary coupling part which is actuable by the motor; and wherein the first and second rotary coupling parts are engageable to transmit drive from the motor to the blending rotor.

12. The food processing apparatus according to claim 11, wherein the upper part is engagable in a dish formation in the lower part and engagement of the upper and lower parts permits the motor to operate.
